(19) United States
(12) Patent Application Publication
(10) Pub. No.: US 2014/0201249 A1
(43) Pub. Date: Jul. 17, 2014

(54) METHOD, SYSTEM, AND COMPUTER PROGRAM PRODUCT FOR ASSOCIATING VISUAL INDICIA WITH A METABOLOMICS ANALYSIS

(71) Applicant: METABOLON, INC., Durham, NC (US)

(72) Inventors: Corey Donald DeHaven, Raleigh, NC (US); Robnet Thornhill Kerns, Durham, NC (US)

(21) Appl. No.: 13/800,010

(22) Filed: Mar. 13, 2013

Related U.S. Application Data
(60) Provisional application No. 61/752,758, filed on Jan. 15, 2013.

(51) Int. Cl. G06F 17/30

(52) U.S. Cl. CPC G06F 17/30572
USPC 707/805

(57) ABSTRACT

A method is provided for analyzing metabolomics data for a plurality of metabolites. Each metabolite is assigned to a node. Nodes are connected according to a defined relationship between corresponding metabolites to form a nodal network. The nodal network is graphically displayed such that at least a portion of the nodes and the relationships therebetween are visible in a single view. An apparatus comprising a processor configured to control the apparatus to analyze metabolomics data for a plurality of metabolites, as well as a computer program product comprising at least one non-transitory computer readable storage medium having computer program code stored thereon, the computer program code being configured to analyze metabolomics data for a plurality of metabolites, are also provided.

### BACKGROUND OF THE DISCLOSURE

1. Field of the Disclosure

Aspects of the present disclosure relate to metabolomics analysis and, more particularly, to a method, system, and computer program product for associating visual indicia with a metabolomics analysis.

2. Description of Related Art

Sophisticated software systems have been developed for processing and analyzing metabolomic datasets. One exemplary system may comprise, for example, core LIMS functionality (sample tracking, management), instrument integration, automated data processing, visualization/reporting tools, data quality/review tools, and statistical analysis functionality. One positive aspect of running studies of consistently high-quality in high-throughput, is that an enormous knowledgebase is formed over time. Metabolites in the library, both known and unknown, that are identified in the studies are associated, for example, with pathways, public id's, physical properties, sample metadata, matrix types, etc. and also contain statistical data in the context of the study. This means that for any particular metabolite, there may be many studies in which that metabolite, for example, was identified, involving multiple pathways, disease states or other associated metadata. This knowledge and accumulated information may be extremely valuable in biomarker discovery, mechanism identification, optimization or other questions pertaining to metabolite function. In this regard, software and hardware systems are readily scalable for sample processing capacity and readily refined for improving data quality.

However, there still exists a bottleneck with respect to this wealth of information, in terms of biochemical interpretation. That is, it may not necessarily be realistic to provide significant automation to the process of metabolite analysis result interpretation, but, lacking such automation, there are significantly limited mechanisms for leveraging this wealth of past knowledge.

There also exist relatively simple pathway associations for metabolites, limited, for example, to super-pathways (e.g., carbohydrate pathways) and sub-pathways (e.g., pyrimidine degradation pathways). However, complex hierarchical associations such as, for example, inter- and intra-pathway relationships, though desirable, may be lacking in the state-of-the-art. This may result, for example, in deficiencies in performing complex biochemical pathway analysis, such as enrichment analysis, and deficiencies in visualizing those identified relationships.

One other deficiency of current available systems is that, for example, since there is no easily accessible storage mechanism for relating metadata, statistics, and pathways, the wealth of metabolite data may not be easily shared and understood by collaborators.

### SUMMARY OF THE DISCLOSURE

The above and other needs are met by aspects of the present disclosure, wherein one such aspect relates to a method for analyzing metabolomics data for a plurality of metabolites. Each metabolite is assigned to a node. Nodes are connected according to a defined relationship between corresponding metabolites to form a nodal network. The nodal network is visually/graphically displayed (i.e., as a graphic) such that at least a portion of the nodes and the relationships therebetween are visible in a single view.

In another aspect of the present disclosure, an apparatus comprising processing circuitry is provided. The processing circuitry of this example embodiment may be configured to control the apparatus to at least perform the steps of the method aspect.

In yet another aspect of the present disclosure, a computer program product is provided comprising at least one non-transitory computer readable storage medium having computer program code stored thereon. The program code of this embodiment may include program code for at least performing the steps of the method aspect upon execution thereof.

Aspects of the present disclosure thus address the identified needs and provide other advantages as otherwise detailed herein. It will be appreciated that the above summary is provided merely for purposes of summarizing some example embodiments so as to provide a basic understanding of some aspects of the disclosure. As such, it will be appreciated that the above described example embodiments are merely examples and should not be construed to narrow the scope or spirit of the disclosure in any way. It will be appreciated that the scope of the disclosure encompasses many potential embodiments, some of which will be further described below, in addition to those here summarized.

### BRIEF DESCRIPTION OF THE SEVERAL VIEWS OF THE DRAWING(S)

Having thus described the disclosure in general terms, reference will now be made to the accompanying drawings, which are not necessarily drawn to scale, and wherein:

FIG. 1 schematically illustrates a method of analyzing metabolomics data for a plurality of metabolites, according to one aspect of the present disclosure;

FIGS. 2-6, 7A, 7B, 8, 9A-9C, 10 and 11 schematically illustrate various aspects of a method, system, and computer program product, according to the present disclosure; and

FIG. 12 schematically illustrates an apparatus configured to implement a method of analyzing metabolomics data for a plurality of metabolites, according to one aspect of the present disclosure.

### DETAILED DESCRIPTION OF THE DISCLOSURE

The present disclosure now will be described more fully hereinafter with reference to the accompanying drawings, in which some, but not all aspects of the disclosure are shown. Indeed, the disclosure may be embodied in many different forms and should not be construed as limited to the aspects set forth herein; rather, these aspects are provided so that this disclosure will satisfy applicable legal requirements. Like numbers refer to like elements throughout.

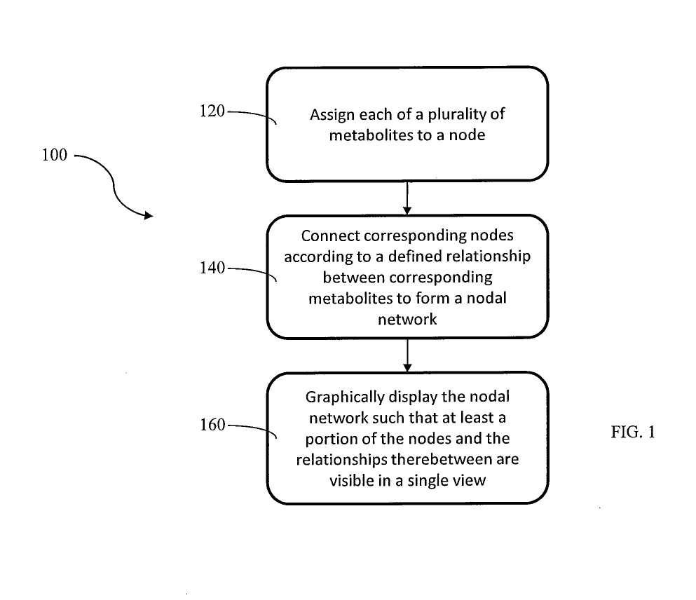

In one aspect, the present disclosure is directed to implementing a system that provides storage, query-tools, and visualization of a biochemical knowledgebase. Such a system may store extensive and, in some instances, complete, biochemical pathway information including, for example, biochemicals, reactants, products, cofactors, directionality, intra-pathway relationships, combinations thereof, and/or any other suitable relationships or associations related to the biochemical pathway information. With such capabilities, aspects of the present disclosure may provide, for example, integration of study data within internal and external ontologies and public data sources, and may also provide advanced query and visualization tools for similarity analysis. That is, in one aspect of the present disclosure, a method 100 is provided (FIG. 1) for analyzing metabolomics data for a plurality of metabolites. Each metabolite is assigned to a node (Block 120). Associated nodes are connected according to a defined relationship between corresponding metabolites to form a nodal network (Block 140). The nodal network is visually/graphically displayed such that at least a portion of the nodes and the relationships therebetween are visible in a single view (Block 160). In some instances, at least one of the nodes and one of the relationships is annotated with at least one of empirical information associated therewith and relational information associated with other nodes and relationships.

In various aspects, the nodal network may be searched according to at least one search characteristic of one of the metabolites, the nodes, the relationships, and the annotations. Such a search characteristic may be, for example, a key word or a chemical formula or structure. The results of the search may be graphically displayed in relation to the nodal network. In some instances, visually/graphically displaying the nodal network further comprises visually/graphically displaying the nodal network such that associated nodes are disposed in visual proximity to each other such that relationships associated with each node are visually distinctive. In addition, an indicia of a relationship between associated nodes can be associated with the respective associated nodes in the nodal network. The indicia of the relationship between associated nodes may be visually/graphically displayed in visual proximity to the associated nodes of the nodal network. In some instances, a relational database can be formed, including the nodes, the metabolites assigned thereto, and the defined relationships between corresponding metabolites. Further, the relational database may be visually displayed in visual proximity to the nodal network. In other instances, the relational database can be visually displayed in a single view separately from the nodal network and toggling the single view between the relational database and the nodal network on demand. In yet other instances, at least a portion of one of the metabolites, the nodes, the relationships, and the annotations, may be associated with a link to external information associated therewith, and retrieving the external information in response to selection of the link.

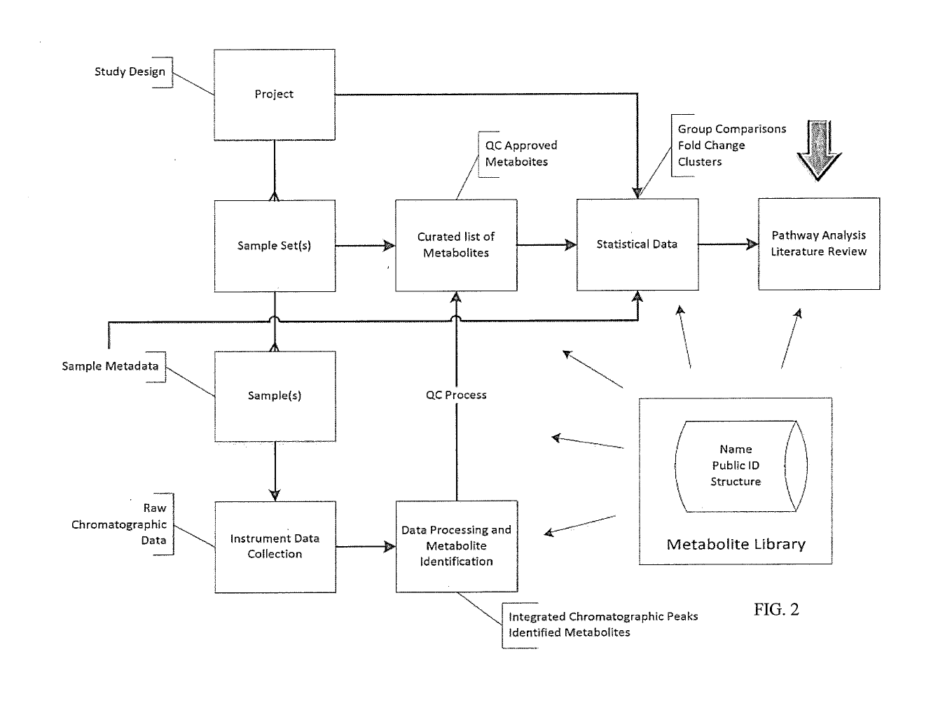

As previously discussed, a software system for the processing and analysis of metabolomic datasets (FIG. 2) may comprise, for example, core LIMS functionality (i.e., sample tracking, management), instrument integration, automated data processing, visualization/reporting tools, data quality/review tools, and statistical analysis functionality. The integration of the distinct software modules required to process and analyze metabolomic studies, and the centralization of such data, allows the process to be pipelined regardless of the study design or number of sample being processed. Such pipelining of the process may be beneficial, for example, in that sample throughput may be enhanced by automated sample and data processing with tools allowing for batch data QC processing. As such, analysis instruments can be utilized to run at specified operational capacity. In other instances, study capacity may be improved since automated sample and data processing may also enable extremely high reproducibility, which allows for high sample numbers within particular studies. Data quality may also be improved by intelligent data processing, result visualization, and QC tools that leverage the batch-oriented nature of the process result in only high-quality data being fed into statistical analysis. Further, improved reproducibility may result from automated data processing, limited human interaction with the data until the visual QC steps, and stable instrumentation. In addition, enhanced scalability may result. Such studies may also increase and capture the value of historical knowledge. That is, since one benefit of running design-independent studies, of consistently high-quality in high-throughput, is that a significant knowledge base may be formed over time in a library. Metabolites in a library, both known and unknown, that are identified in these studies are associated with certain “metabolite metadata” such as, for example, pathways, public id's, physical properties, sample metadata, matrix types, etc. and also contain statistical data in the context of the study. As such, for any particular metabolite, there may be many studies in which that metabolite was identified and discovered to involve multiple pathways, disease states or other associated metadata. This extensive knowledge may be particularly valuable, for example, in biomarker discovery, mechanism, optimization or other questions pertaining to function. Further, one skilled in the art will appreciate that, though reference is made herein to aspects of the method, system, and computer program product being particularly directed to metabolites and metabolomic systems, such reference is for exemplary purposes only. That is, one skilled in the art will appreciate that aspects of the method, system, and computer program product disclosed herein may be similarly and readily applicable to any biologic data accumulated in an extensive knowledgebase (i.e., generally any “-omics” data such as, for example, transcriptomics, proteomics, DNA copy number, etc.). As such, the examples presented herein involving metabolites/metabolomic systems are not intended to be limiting to the applicability of such aspects of the methods, systems, and computer program products herein in any manner.

In some aspects, the present disclosure is directed to determining a biological meaning, definition, relationship, or the like for metabolite data sets, using assets such as, for example, study context available through study design information, matrix parameters, and sample metadata. In addition, such data sets may include lists of statistically significant metabolites with associated statistical values and public identifiers, and/or data from other studies (including, for instance, associated design information, sample types, metadata, statistics, metabolites, etc.). In determining a biological interpretation, it may be helpful, for a group of statistically significant metabolites, to determine, for example, common pathways that may be affected; internal historical experience (i.e., metabolites up- or down-regulated), external historical experience (i.e., publications); any changes for a given drug (i.e., changes in metabolite across data sets); any other groups of metabolites that may be affected by the same enzymes; any pathways that may be affected by varying NAD levels; any correlation of low NAD levels to a list of pathways; and/or other relationships. In making some of these determinations, some required information may include, for example, a list of affected pathways; knowledge of common reactions and/or enzymes of affected pathways; and results of public literature searches based on a particular list of metabolites.

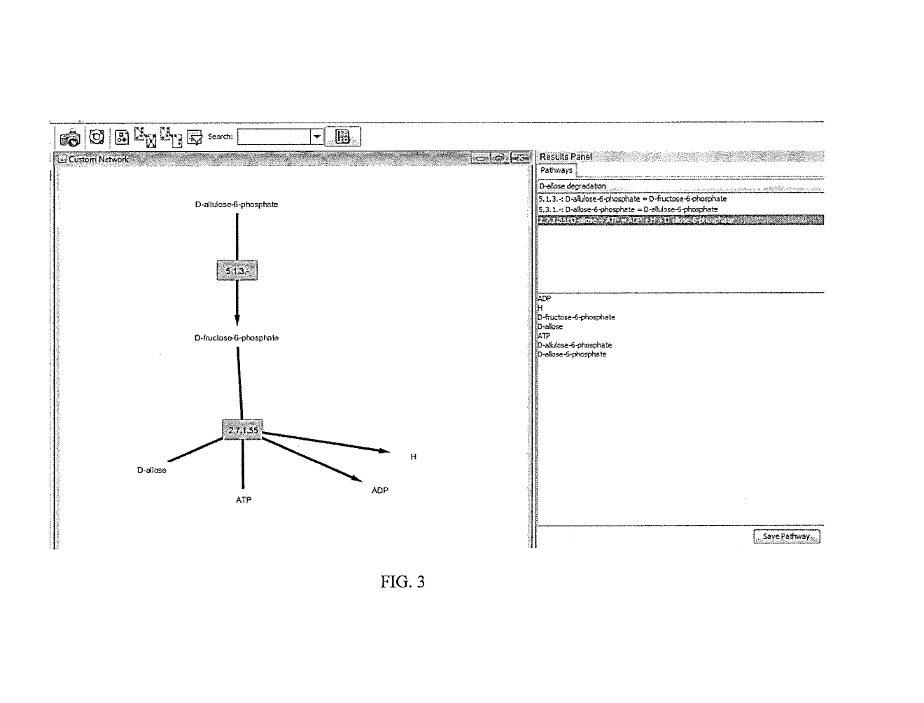

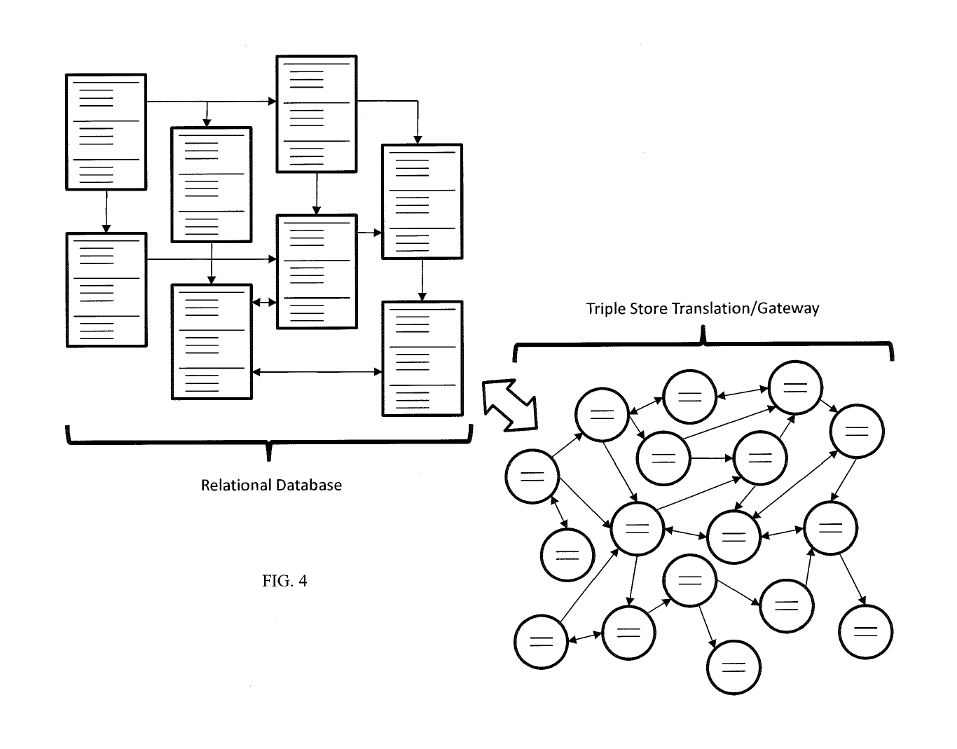

An initial aspect of the functionality of systems, methods, and computer program products of the present disclosure includes defining an initial framework, including particular nodes and relationships, for example, from an internal knowledge base of metabolites and discovered characteristics from particular studies (FIG. 3). In this regard, particular aspects may include, for example, a relational database to triple store translation/gateway functionality (see, e.g., FIG. 4) with toggling therebetween. That is, in some instances, a translator may be required to translate the internal metabolite data stored in a particular relational schema and into a triple store (i.e., a graphic). This transition of internal metabolite study data to the triple store may be a selective or gated process controlled, for example, by a project director. As such, one skilled in the art will appreciate that not all internal metabolite studies will necessarily be converted. The converted categories may include relational objects or parameters, such as, for example, client name/ID; project name/ID; sample set (study) name/ID; organism; species; matrix; matrix type; sample metadata [name/value pair]; metabolites; statistical values [name/value pair]; pathway; public identifiers; and/or combinations thereof (FIG. 4).

In another aspect, such functionality may include, for example, an editing tool configured to edit, for example, ontology values, network associations/relationships, etc. More particularly, such an editing tool may be configured to add ontology values or structures not contained in the relational schema and/or to create relationships across objects and/or to external ontology sources.

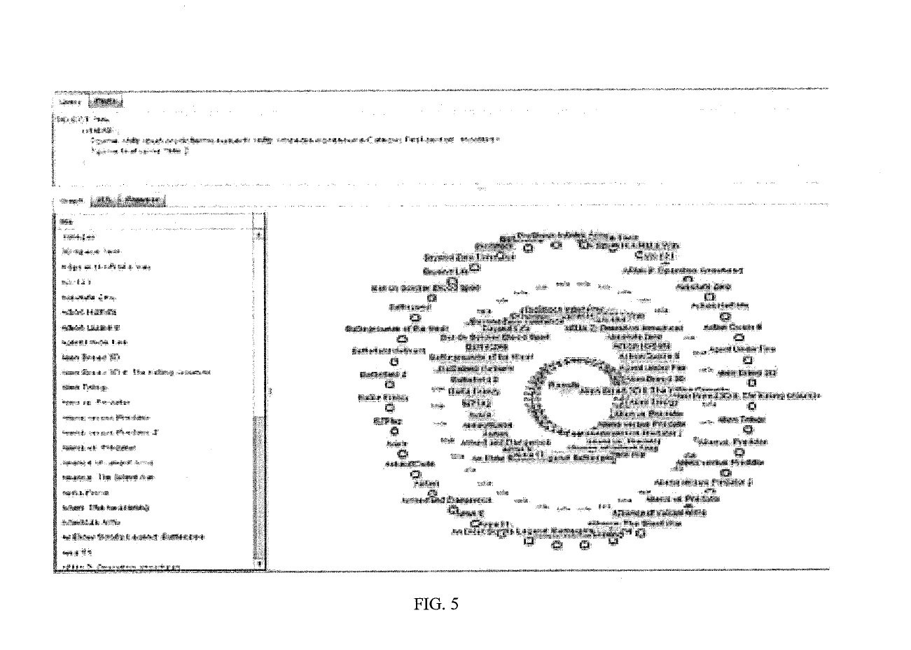

Yet another aspect involves a manipulation engine or tool configured to allow a user to run queries on the metabolite data and/or provide visualization of that data. More particularly, such a manipulation engine or tool may be configured to perform predetermined or custom queries of the triple store, and allow the user to visualize and/or report on the results (i.e., visualize results in a graphical environment or as a graphic depicting relevant nodes and relationships therebetween). In some instances, the manipulation engine/tool may also be configured to include a back-end engine or component for conducting multiple advanced queries to determine, for example, historical and/or public relationships, wherein the results of these advanced queries may also be graphically displayed and otherwise manipulated, for example, by an mlims application (i.e., a theme generator) (FIG. 5).

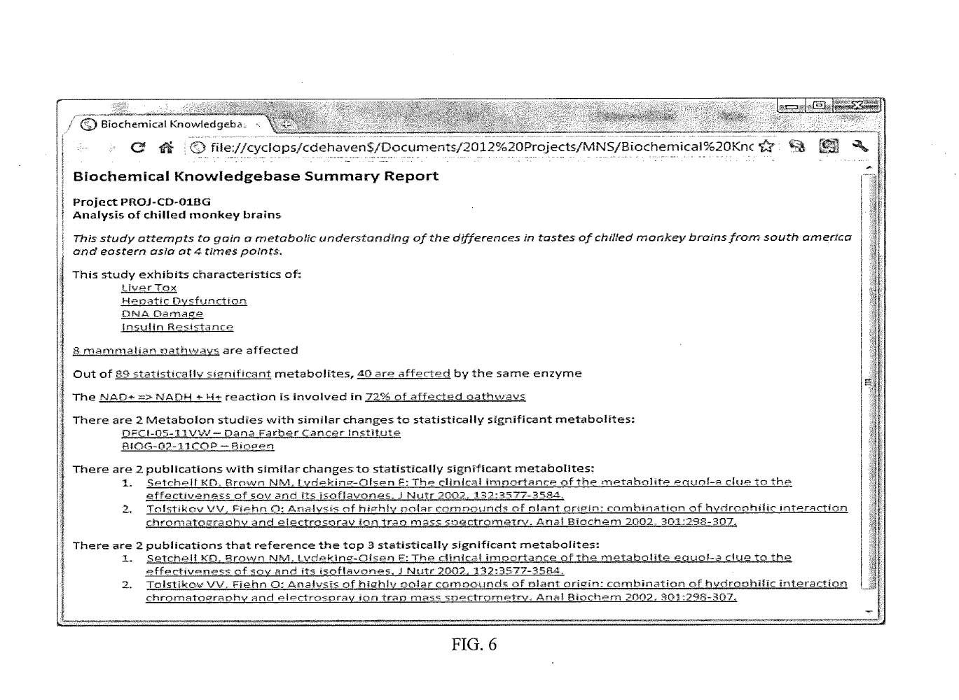

In some instances, the manipulation engine/tool may be configured to analyze the metabolite data to identify characteristics indicating predetermined analysis situations (i.e., a theme generator for identifying themes) (FIG. 6). In such situations, for example, the results of an analysis may result in a web-page being presented to the user with answers (or indicators) in response to the query which may include links to various tools corresponding to the nature of the results and/or original query. Aspects directed to the mlims integration and visualization features may, in some instances, require access to the triple store via web service methods. In some instances, particular components such as reports, the theme generator, and/or the actuation of the analysis itself may be launched from the mlims application or may utilize data retrieved by web services, wherein such functionality may be integrated directly into the mlims application framework or may be run or executed externally thereto.

In other aspects, the systems, methods, and computer program products of the present disclosure may require, for example, identification of the various semantic schemas (i.e., ontologies) applicable to an existing data library; implementation of an appropriate storage mechanism for the knowledge base utilizing the identified schemas integrated with an existing relational database; query functionality/visualization/reporting of the data within the knowledge base; and exporting of that data in standard formats. In addition to storing the biochemical knowledge base, and building a network of chemical pathways/relationships/associations in diverse functional areas such as, for example, disease, matrix, observation, clinical value, etc., tools may be implemented for editing, searching, and providing visualization network data for associated users.

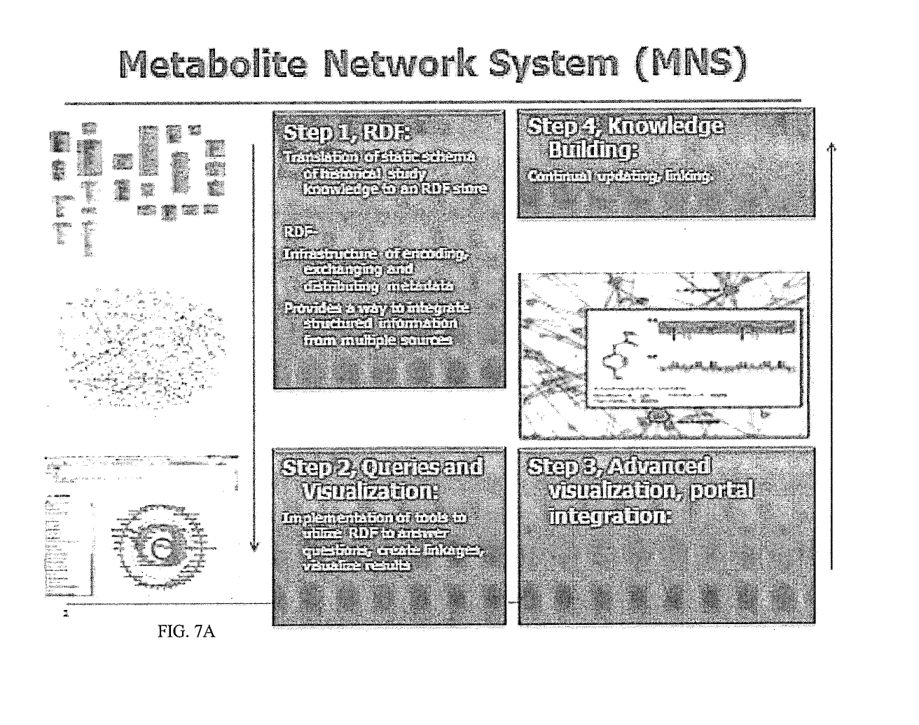

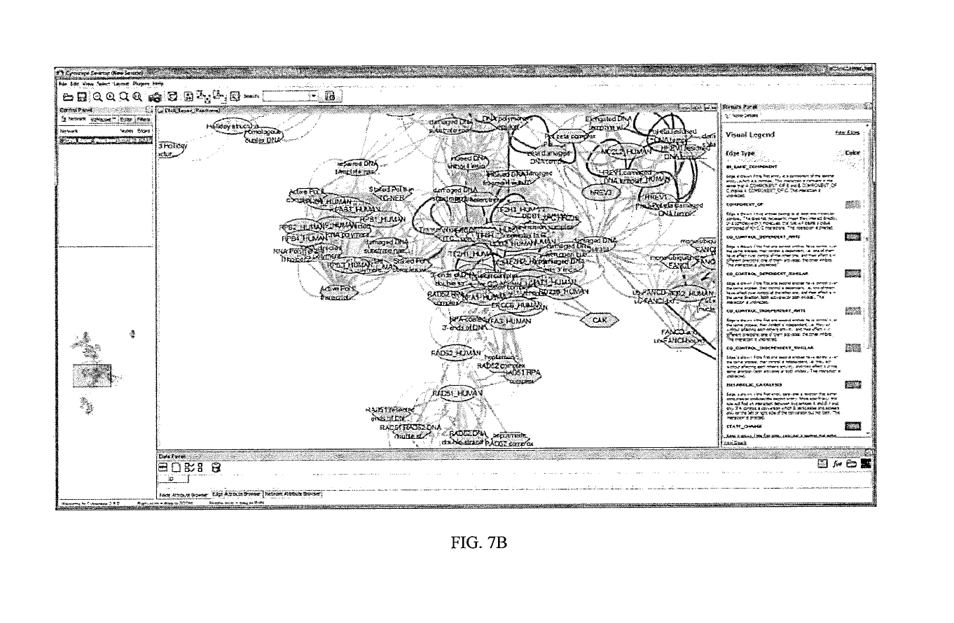

One skilled in the art will appreciate that there may exist certain desktop-based, modular, open-source platforms for network visualization and analysis (e.g., see FIG. 2). As such, particular “plugins” may be developed to provide additional functionality to the platform for particular data architectures and analysis schemes for certain networks. As such, aspects of the systems, methods, and computer program products of the present disclosure may be implemented, configured, associated with, and/or realized as a plugin for such platforms, which may particularly allow visualization of large networks (i.e., metabolite nodal networks, as disclosed herein, or at least a portion thereof, in a single view), as well as research and analysis associated therewith. Graphic visualization features are customizable from providing various types of graphs (e.g., cyclic, directed, tree, etc.) to the annotation of individual nodes and/or pathways/relationships/associations. In some aspects, users can map several images, annotations, or the like for each node and, having the ability to navigate through the nodal network, may readily be able to visualize large scale networks such as, for instance, the human interactome. In some aspects, various types of charts may be mapped to the nodes, as a custom graphics function. In other instances, the user may have the capability to browse chemical structures of metabolites in a specific user panel or directly in the relevant nodes (FIGS. 7A and 7B).

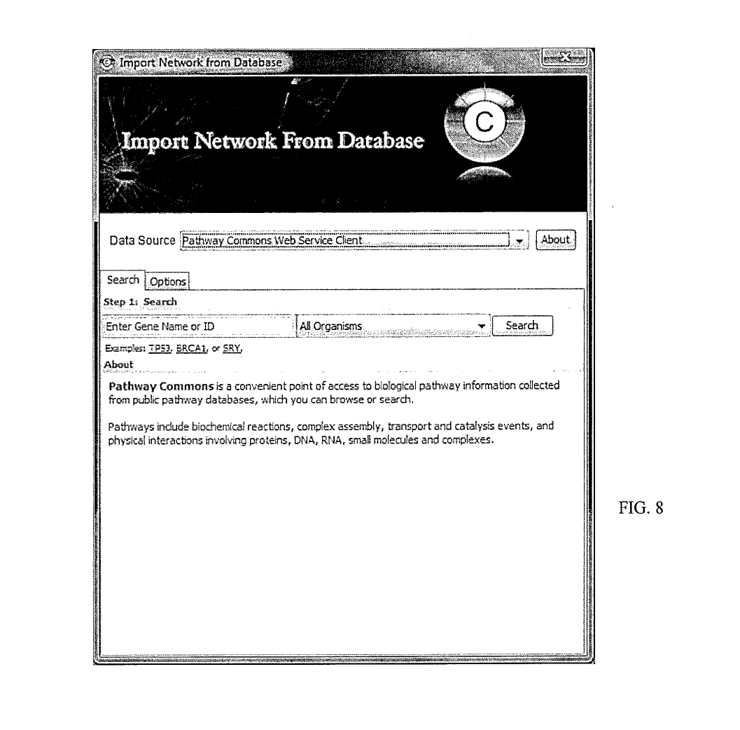

In other aspects, the systems, methods, and computer program products of the present disclosure may be configured as a web service client, for example, by directly connecting to external databases, and importing network data and annotation data. Several public databases may be available for download via specific queries (FIG. 8). Graphics-based analysis tools, such as node clustering and filtering, may also extend the functionality disclosed herein. Additional cheminformatics software tools can also be used by the plugin configuration via external program piping, as necessary or desired, wherein such tools can be integrated to provide or otherwise be incorporated into a user-friendly (graphical) interface.

In particular aspects, efficient loading and mapping of the structured metabolite ontology may be implemented synergistically with other chemical/biological data available from other sources such as, for example, the public domain. Appropriately structured and accessible data storage may facilitate efficient loading of large amounts of data, as involved, for example, with chemical and biological data in metabolomic analysis. In this regard, certain systems, such as a text-based data management system, may allow rapid communication between aspects of the systems, methods, and computer program products of the present disclosure, and the metabolomics database, and may include necessary information, such as metabolite name, chemical structure, internal and external ids, and/or will allow any necessary data to be retrieved as necessary. Files may be encrypted, as necessary, and depending on the user's privileges, certain parts of the information could be hidden on the front-end desktop application. In turn, the metabolomics database may be enhanced by associating, with each metabolite, other public database identifiers that may be available, such as PubChem_id, Chemspider_id, Gene_id, ChEBI_id, STITCH_id, CTD_id, and PDB_id. Associating metabolites with public data entries may facilitate the retrieval of diverse information spread across multiple public data sources, particularly online data sources, wherein automatic search of such identifiers may be facilitated by different cheminformatics software tools.

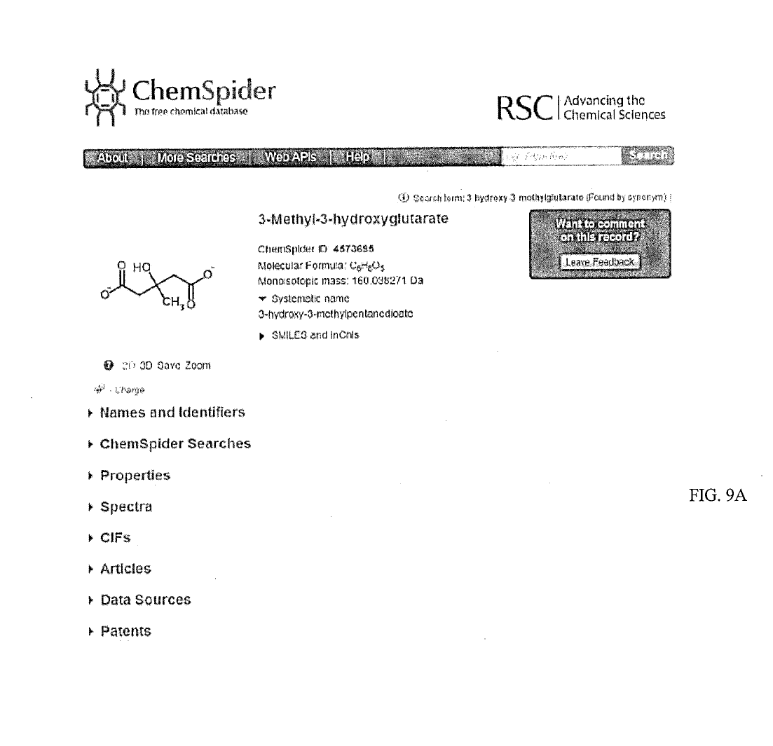

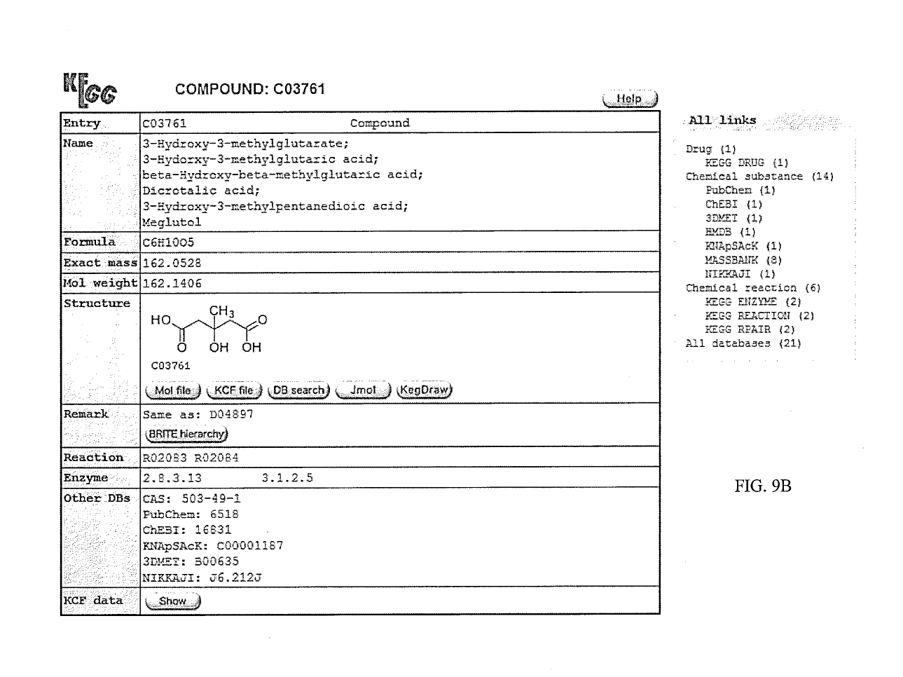

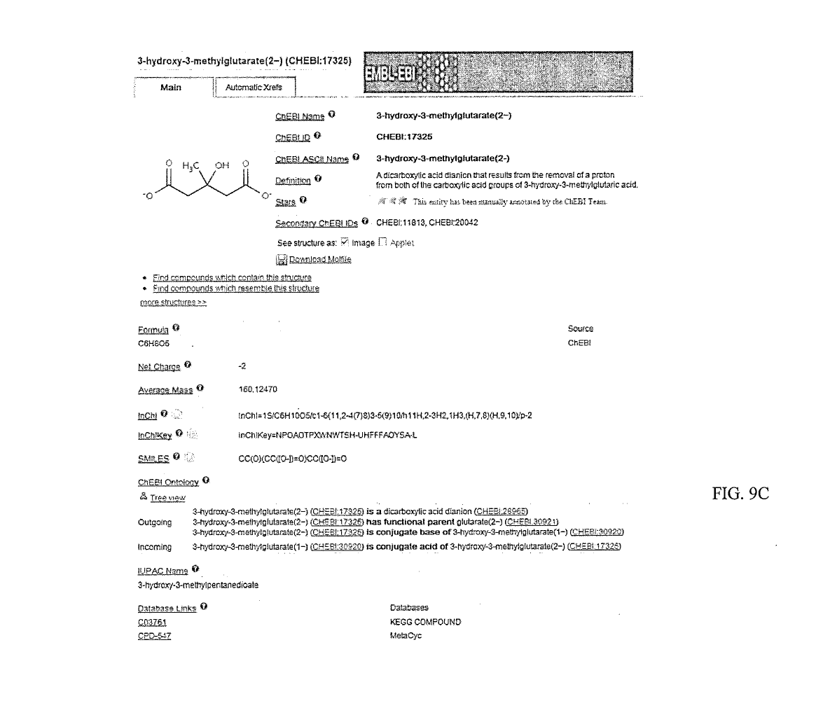

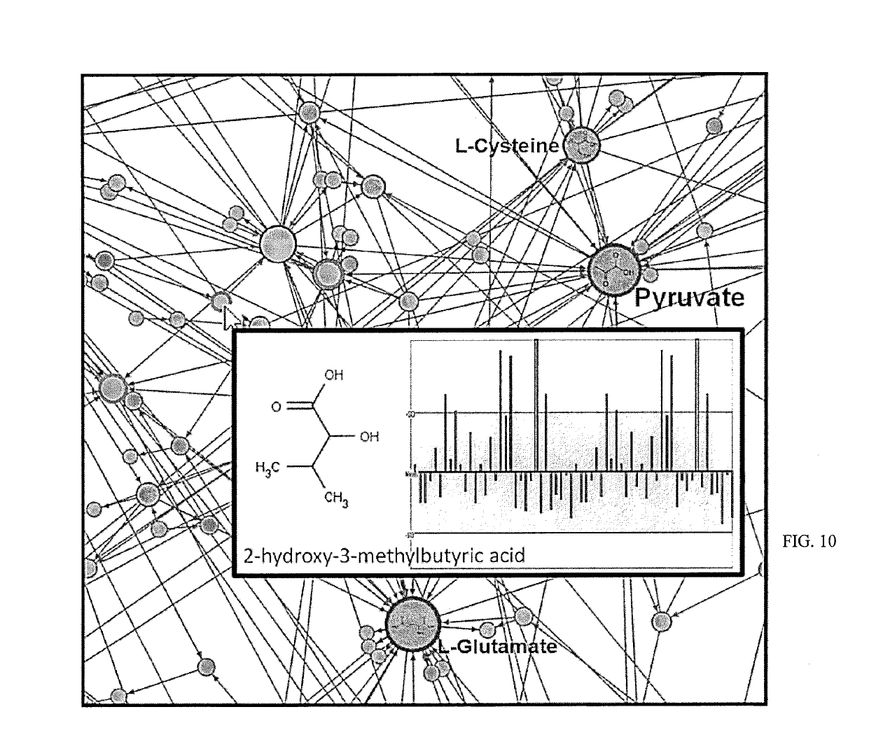

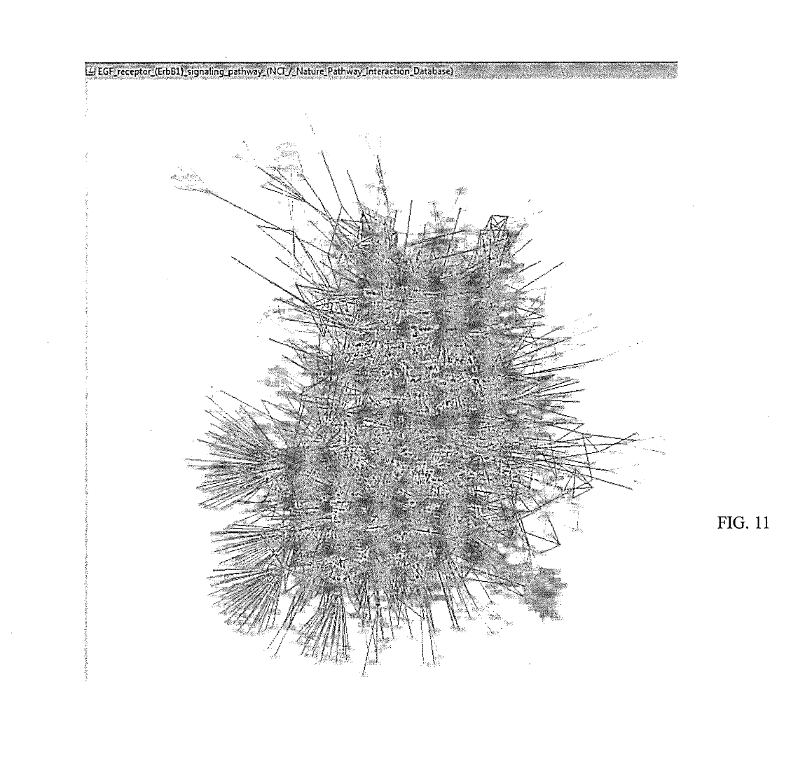

In one example, 3-methyl-3-hydroxyglutarate (Internal ID=144) may have, in an enriched database, the following information associated with this particular metabolite: Chemspider ID=4573695 (FIG. 9A), KEGG ID=C03761 (FIG. 9B), and ChEMBL ID=17325 (FIG. 9C). Substantially instantaneously available, when queried, this information may be displayed on a graphic-user interface associated with the plugin according to the aspects, the systems, methods, and computer program products of the present disclosure (see FIG. 10). Active hyperlinks associated with the display may allow ready accessibility to external chemical/biological knowledge stored, for example, in Chemspider, ChEMBL and/or KEGG databases. Aspects of the aspects, the systems, methods, and computer program products of the present disclosure may also facilitate access, download, and visualization of large networks of chemical/biological pathways/relationships/associations, with additional functionality/features for highlighting particular features, wherein such functionality may include, for example, a standardized or extended color scheme and/or additional node/pathway annotation. For instance, graph indices may be available to characterize each network and quickly and readily identify hubs (i.e., nodes with a high vertex degree) or appropriate neighborhoods (e.g., metabolites that interact with at least two receptor proteins and another biological data type defined by a user) (FIG. 11). Aspects of the present disclosure may also provide the ability to browse and explore these networks using different user-friendly procedures and filters, using simple (e.g., metabolite identifiers) and complex (e.g., substructural similarity search) technologies, as appropriate. As such, users may, for example, be able to search across different pathways/relationships/associations for a particular metabolite based on any of its identifiers (see, e.g., FIG. 7A), or search for a set of metabolites based on chemical similarity to the user's query. In visualizing the results of such queries in a graphical format (i.e., displayed on a monitor or screen of a computer device), the users may not only view the actual results of the query, but may also view other nodes/relationships that are not included in the actual results but may be otherwise similar to, associated with, other otherwise relevant to the actual results (i.e., relevant information that may not have otherwise been seen from the actual results of the user query). Further, advanced data exploration tools such as, for example, analysis tools enabling enrichment analysis of cofactors via measurement of proximal metabolites, may also be included in some aspects of the present disclosure. Such advanced data exploration tools may, in some instances, be configured to apply statistical algorithms to the data in the context of the nodal network, wherein the results of such statistical procedures may be realized in association with the visually displayed results of the user query (i.e., such tools may, for example, statistically “rank” the relevant data related to the user query and present the relevant data, in response to the user query, in accordance with the relative statistical importance thereof).

In some instances, when metabolite profiles are available for a single, a group, or multiple groups (e.g., control vs. disease) of patients at different time points, aspects of the systems, methods, and computer program products of the present disclosure may allow the user to browse these profiles directly mapped on the pathway/relationship/association networks (see, e.g., FIG. 10) via dynamic frames that appear when a node is selected. In such instances, users may be directed to metabolite nodes that include the most significant profile variations for facilitating the analysis. Upon request, other types of information may be displayed in these dynamic frames, wherein such information may include, for example, public database ids, chemical structures, most similar metabolites, etc.

In yet another aspect of the present disclosure, a computer program product is provided comprising at least one non-transitory computer readable storage medium having computer program code stored thereon. The program code of this embodiment may include program code for at least performing the steps of the method aspect upon execution thereof. That is, it will be understood that each block of the flowchart in FIG. 1, and/or combinations of blocks in the flowchart, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s), which may embody the procedures described herein, may be stored by one or more memory devices of a mobile terminal, server, or other suitable computing device and executed by a processor in the computing device. In some embodiments, the computer program instructions comprising the computer program product(s) which embody the procedures described above may be stored by memory devices of a plurality of computing devices. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s). Accordingly, blocks of the flowchart support combinations of means for performing the specified functions. It will also be understood that one or more blocks of the flowchart, and combinations of blocks in the flowchart, may be implemented by special purpose hardware-based computer systems which perform the specified functions, or combinations of special purpose hardware and computer program product(s).

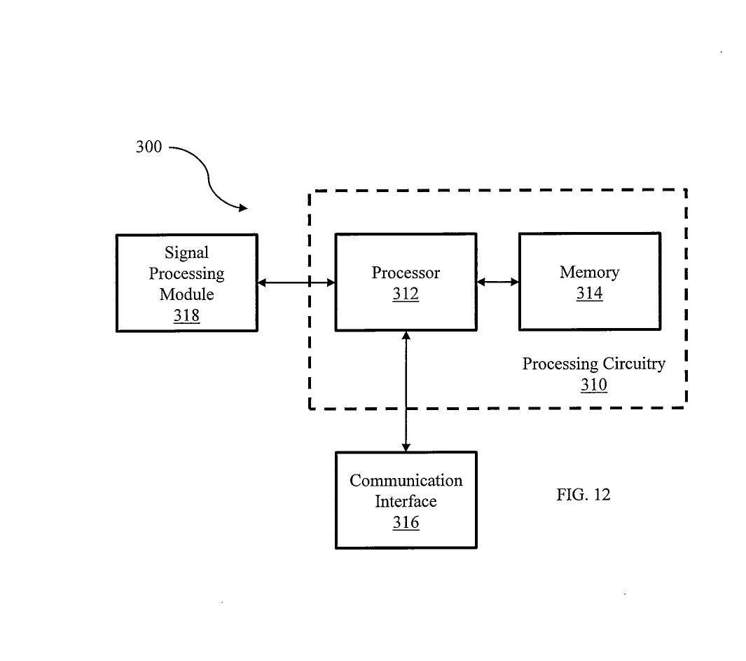

In yet another aspect of the present disclosure, an apparatus comprising processing circuitry, or at least an appropriate processor, is provided. The processing circuitry of this example embodiment may be configured to control the apparatus to at least perform the steps of the method aspect. In this regard, FIG. 12 illustrates a block diagram of an apparatus 300 that can be implemented on a server in accordance with some example embodiments. In this regard, when implemented on a computing device, such as a server, apparatus 300 can enable a computing device to operate within a system in accordance with one or more example embodiments. It will be appreciated that the components, devices or elements illustrated in and described with respect to FIG. 12 below may not be mandatory and thus some may be omitted in certain embodiments. Additionally, some embodiments can include further or different components, devices or elements beyond those illustrated in and described with respect to FIG. 12.

In some example embodiments, the apparatus 300 can include processing circuitry 310 that is configurable to perform actions in accordance with one or more example embodiments disclosed herein, such as method aspects previously disclosed. In this regard, the processing circuitry 310 can be configured to perform and/or control performance of one or more functionalities of the apparatus 300 in accordance with various example embodiments, and thus can provide means for performing functionalities of the apparatus 300 in accordance with various example embodiments. The processing circuitry 310 can be configured to perform data processing, application/software execution and/or other processing and management services according to one or more example embodiments.

In some embodiments, the apparatus 300 or a portion(s) or component(s) thereof, such as the processing circuitry 310, can include one or more chipsets, which can each include one or more chips. The processing circuitry 310 and/or one or more further components of the apparatus 300 can therefore, in some instances, be configured to implement an embodiment on a single chip or chipset. In some example embodiments in which one or more components of the apparatus 300 are embodied as a chipset, the chipset can be capable of enabling a computing device to operate in the system 200 when implemented on or otherwise operably coupled to the computing device. Thus, for example, one or more components of the apparatus 300 can provide a chipset configured to enable a computing device to operate over a network.

In some example embodiments, the processing circuitry 310 can include a processor 312 and, in some embodiments, such as that illustrated in FIG. 12, can further include a memory 314. The processing circuitry 310 can be in communication with or otherwise control a communication interface(s) 316 and/or selection control module 318, as further disclosed herein.

The processor 312 can be embodied in a variety of forms, as will be appreciated by one of ordinary skill in the art. For example, the processor 312 can be embodied as various processing means such as a microprocessor, a coprocessor, a controller or various other computing or processing devices including integrated circuits such as, for example, an application-specific integrated circuit (ASIC), a field-programmable gate array (FPGA), some combination thereof, or the like. Although illustrated as a single processor, it will be appreciated that the processor 312 can comprise a plurality of processors. The plurality of processors can be in operative communication with each other and can be collectively configured to perform one or more functionalities of the apparatus 300 as described herein. In some example embodiments, the processor 312 can be configured to execute instructions that can be stored in the memory 314 or that can be otherwise accessible to the processor 312. As such, whether configured by hardware or by a combination of hardware and software, the processor 312 is capable of performing operations according to various embodiments while configured accordingly.

In some example embodiments, the memory 314 can include one or more memory devices. The memory 314 can include fixed and/or removable memory devices. In some embodiments, the memory 314 can provide a non-transitory computer-readable storage medium that can store computer program instructions (i.e., software) that can be executed by the processor 312. In this regard, the memory 314 can be configured to store information, data, applications, instructions and/or the like for enabling the apparatus 300 to carry out various functions in accordance with one or more example embodiments, such as the method aspects disclosed herein. In some embodiments, the memory 314 can be in communication with one or more of the processor 312, communication interface(s) 316, or selection control module 318 via a bus(es) for passing information among components of the apparatus 300.

The apparatus 300 may further include a communication interface 316. The communication interface 316 may enable the apparatus 300 to receive a signal that may be sent by another computing device, such as over a network. In this regard, the communication interface 316 may include one or more interface mechanisms for enabling communication with other devices and/or networks. As such, the communication interface 316 may include, for example, an antenna (or multiple antennas) and supporting hardware and/or software for enabling communications with a wireless communication network (e.g., a cellular network, WLAN, and/or the like) and/or a communication modem or other hardware/software for supporting communication via cable, digital subscriber line (DSL), USB, FireWire, Ethernet or other wireline networking methods.

The apparatus 300 can further include selection control module 318. The selection control module 318 can be embodied as various means, such as circuitry, hardware, a computer program product comprising a computer readable medium (for example, the memory 314) storing computer readable program instructions and executable by a processing device (for example, the processor 312), or some combination thereof for performing particular operations or functions of aspects of the present disclosure, as otherwise disclosed herein. In some embodiments, the processor 312 (or the processing circuitry 310) can include, or otherwise control the selection control module 318.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

That which is claimed:

1. A method of analyzing metabolomics data for a plurality of metabolites, comprising:
assigning each metabolite to a respective node;
connecting nodes according to a defined relationship between corresponding metabolites to form a nodal network; and
graphically displaying the nodal network such that at least a portion of the nodes and the relationships therebetween are visible in a single view.

2. A method according to claim 1, further comprising annotating at least one of one of the nodes and one of the relationships with at least one of empirical information associated therewith and relational information associated with other nodes and relationships.

3. A method according to claim 2, further comprising searching the nodal network according to at least one search characteristic of one of the metabolites, the nodes, the relationships, and the annotations.

4. A method according to claim 2, further comprising graphically displaying results of the search in relation to the nodal network.

5. A method according to claim 1, wherein graphically displaying the nodal network further comprises graphically displaying the nodal network such that associated nodes are disposed in visual proximity to each other such that relationships associated with each node are visually distinctive.

6. A method according to claim 5, further comprising associating an indicia of a relationship between associated nodes with the respective associated nodes in the nodal network.

7. A method according to claim 6, further comprising visually displaying the indicia of the relationship between associated nodes in visual proximity to the associated nodes of the nodal network.

8. A method according to claim 1, further comprising forming a relational database including the nodes, the metabolites assigned thereto, and the defined relationships between corresponding metabolites.

9. A method according to claim 8, further comprising visually displaying the relational database in visual proximity to the nodal network.

10. A method according to claim 8, further comprising visually displaying the relational database in a single view separately from the nodal network and toggling the single view between the relational database and the nodal network on demand.

11. A method according to claim 2, further comprising associating at least a portion of one of the metabolites, the nodes, the relationships, and the annotations, with a link to external information associated therewith, and retrieving the external information in response to selection of the link.

12. An apparatus comprising a processor configured to control the apparatus to analyze metabolomics data for a plurality of metabolites, by at least:
assigning each metabolite to a respective node;
connecting nodes according to a defined relationship between corresponding metabolites to form a nodal network; and
graphically displaying the nodal network such that at least a portion of the nodes and the relationships therebetween are visible in a single view.

13. An apparatus according to claim 12, wherein the processor is further configured to control the apparatus to annotate at least one of one of the nodes and one of the relationships with at least one of empirical information associated therewith and relational information associated with other nodes and relationships.

14. An apparatus according to claim 13, wherein the processor is further configured to control the apparatus to search the nodal network according to at least one search characteristic of one of the metabolites, the nodes, the relationships, and the annotations.

15. An apparatus according to claim 13, wherein the processor is further configured to control the apparatus to graphically display results of the search in relation to the nodal network.

16. An apparatus according to claim 12, wherein the processor is further configured to control the apparatus to graphically display the nodal network such that associated nodes are disposed in visual proximity to each other such that relationships associated with each node are visually distinctive.

17. An apparatus according to claim 16, wherein the processor is further configured to control the apparatus to associate an indicia of a relationship between associated nodes with the respective associated nodes in the nodal network.

18. An apparatus according to claim 17, wherein the processor is further configured to control the apparatus to visually display the indicia of the relationship between associated nodes in visual proximity to the associated nodes of the nodal network.

19. An apparatus according to claim 12, wherein the processor is further configured to control the apparatus to form a relational database including the nodes, the metabolites assigned thereto, and the defined relationships between corresponding metabolites.

20. An apparatus according to claim 19, wherein the processor is further configured to control the apparatus to visually display the relational database in visual proximity to the nodal network.

21. An apparatus according to claim 19, wherein the processor is further configured to control the apparatus to visually display the relational database in a single view separately from the nodal network and to toggle the single view between the relational database and the nodal network on demand.

22. An apparatus according to claim 13, wherein the processor is further configured to control the apparatus to associate at least a portion of one of the metabolites, the nodes, the relationships, and the annotations, with a link to external information associated therewith, and retrieve the external information in response to selection of the link.

23. A computer program product comprising at least one non-transitory computer readable storage medium having computer program code stored thereon, the computer program code being configured to analyze metabolomics data for a plurality of metabolites, and comprising:
program code for assigning each metabolite to a node;
program code for connecting nodes according to a defined relationship between corresponding metabolites to form a nodal network; and
program code for graphically displaying the nodal network such that at least a portion of the nodes and the relationships therebetween are visible in a single view.

24. A computer program product according to claim 23, further comprising program code for annotating at least one of one of the nodes and one of the relationships with at least one of empirical information associated therewith and relational information associated with other nodes and relationships.

25. A computer program product according to claim 24, further comprising program code for searching the nodal network according to at least one search characteristic of one of the metabolites, the nodes, the relationships, and the annotations.

26. A computer program product according to claim 24, further comprising program code for graphically displaying results of the search in relation to the nodal network.

27. A computer program product according to claim 23, wherein the program code for graphically displaying the nodal network further comprises program code for graphically displaying the nodal network such that associated nodes are disposed in visual proximity to each other such that relationships associated with each node are visually distinctive.

28. A computer program product according to claim 27, further comprising program code for associating an indicia of a relationship between associated nodes with the respective associated nodes in the nodal network.

29. A computer program product according to claim 28, further comprising program code for visually displaying the indicia of the relationship between associated nodes in visual proximity to the associated nodes of the nodal network.

30. A computer program product according to claim 23, further comprising program code for forming a relational database including the nodes, the metabolites assigned thereto, and the defined relationships between corresponding metabolites.

31. A computer program product according to claim 30, further comprising program code for visually displaying the relational database in visual proximity to the nodal network.

32. A computer program product according to claim 30, further comprising program code for visually displaying the relational database in a single view separately from the nodal network and for toggling the single view between the relational database and the nodal network on demand.

33. A computer program product according to claim 24, further comprising program code for associating at least a portion of one of the metabolites, the nodes, the relationships, and the annotations, with a link to external information associated therewith, and for retrieving the external information in response to selection of the link.
